(19) United States
(12) Patent Application Publication
(10) Pub. No.: US 2020/0225023 A1
(43) Pub. Date: Jul. 16, 2020

(54) INFORMATION PROCESSING APPARATUS

(71) Applicant: Panasonic Intellectual Property Management Co., Ltd., Osaka (JP)

(72) Inventors: Ryuichi OKAMOTO, Osaka (JP); Masaki MUKAI, Hyogo (JP); Yuka SAKURAI, Hyogo (JP)

(21) Appl. No.: 16/832,450

(22) Filed: Mar. 27, 2020

Related U.S. Application Data
(63) Continuation of application No. PCT/JP2018/036076, filed on Sep. 27, 2018.

(30) Foreign Application Priority Data
Sep. 28, 2017 (JP) 2017-187810

(51) Int. Cl. G01B 11/02; H04N 5/225

(52) U.S. Cl. CPC G01B 11/026; H04N 5/22525; H04N 5/2254

(57) ABSTRACT

An information processing apparatus includes a processor configured to control the whole of the information processing apparatus, a display unit, an input unit layered on the display unit, a visible light camera configured to acquire a visible image of a subject, and a distance-measuring camera. The processor displays the visible image acquired by the visible light camera on the display unit, detects a user-specified position on the visible image specified by a user via the input unit, and confirms whether each position on the visible image is located on a near side by a predetermined value or more relative to the user-specified position on the basis of information on distance measured by the distance-measuring camera and corrects, when positions located on the near side by the predetermined value or more are present in the predetermined range, the user-specified position to a position located on nearest side out of the positions.

### CROSS-REFERENCE TO RELATED APPLICATIONS

This is a continuation application of International Application No. PCT/JP2018/036076, with an international filing date of Sep. 27, 2018, which claims priority of JP 2017-187810 filed on Sep. 28, 2017, the content of which is incorporated herein by reference.

### BACKGROUND

### Technical Field

The present disclosure relates to an information processing apparatus having a function of measuring a spatial distance.

### Related Art

JP 2013-156925 A discloses an electronic apparatus including a touch panel configured to correct a deviation between a touch position corresponding to a user's intension and a touch detection position.

### SUMMARY

The present disclosure provides an information processing apparatus that allows a user to accurately specify a desired measurement position.

An information processing apparatus according to the present disclosure includes a processor configured to control the whole of the information processing apparatus, a display unit, an input unit layered on the display unit, a visible light camera configured to acquire a visible image of a subject, and a distance-measuring camera configured to measure distance to each object in the subject. The processor displays the visible image acquired by the visible light camera on the display unit, detects a user-specified position on the visible image specified by a user via the input unit, and confirms whether each position on the visible image within a predetermined range from the user-specified position detected on the visible image is located on a near side by a predetermined value or more relative to the user-specified position on the basis of information on distance measured by the distance-measuring camera and corrects, when positions located on the near side by the predetermined value or more are present in the predetermined range, the user-specified position to a position located on a nearest side out of the positions.

The information processing apparatus according to the present disclosure allows a user to accurately specify a desired measurement position.

### BRIEF DESCRIPTION OF DRAWINGS

FIGS. 1A and 1B are external views of an information processing apparatus according to an embodiment of the present disclosure;

FIG. 2 is a block diagram showing an internal structure of the information processing apparatus according to the embodiment of the present disclosure;

FIG. 3 is a block diagram showing an example of a structure of a distance-measuring camera unit included in the information processing apparatus according to the embodiment of the present disclosure;

FIG. 4 is a diagram showing an example of user-specified position correction information according to the embodiment of the present disclosure;

FIG. 5 is a flowchart showing operation of the information processing apparatus according to the embodiment of the present disclosure, in which the information processing apparatus calculates distance between two user-specified positions and presents the distance to a user; and

FIG. 6 is a flowchart showing operation of the information processing apparatus according to the embodiment of the present disclosure, in which the information processing apparatus corrects the user-specified position.

### DETAILED DESCRIPTION

An embodiment will be described in detail below with appropriate reference to the drawings. However, a detailed description more than necessary may be omitted. For example, a detailed description of a well-known matter and a redundant description on substantially the same structure may be omitted. This is to avoid the following description being unnecessarily redundant and to help those skilled in the art to easily understand the following description.

The accompanying drawings and the following description are provided to help those skilled in the art to fully understand the present disclosure and are not intended to limit the subject matter of the claim.

### Embodiment

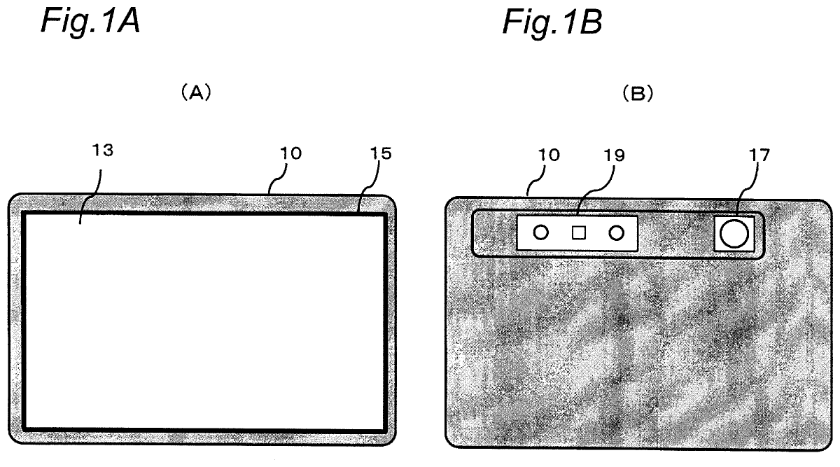

The embodiment will be described below with reference to FIG. 1A to FIG. 6.

### [1-1-1. Structure of Information Processing Apparatus]

FIGS. 1A and 1B are external views of an information processing apparatus 10 according to the embodiment of the present disclosure. FIG. 1A is a front view of the information processing apparatus 10, and FIG. 1B is a rear view of the information processing apparatus 10. The information processing apparatus 10 corresponds to a so-called tablet terminal. The information processing apparatus 10 includes a display unit 13 and a touch panel 15 on a front side of the information processing apparatus 10. The touch panel 15 is layered on the display unit 13 and serves as an input unit. The information processing apparatus 10 includes a visible light camera 17 and a distance-measuring camera unit 19 on a rear side of the information processing apparatus 10.

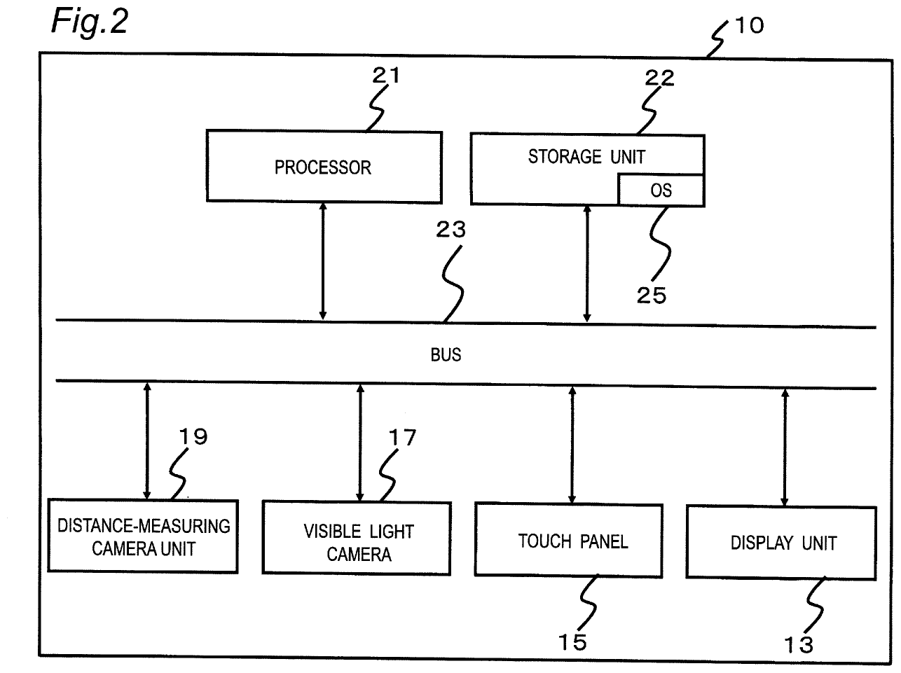

FIG. 2 is a block diagram showing an internal structure of the information processing apparatus 10. The information processing apparatus 10 includes a processor 21, a storage unit 22, a bus 23, an operating system (OS) 25, the display unit 13, the touch panel 15, the visible light camera 17, and the distance-measuring camera unit 19.

The processor 21 runs a program to control the other components of the information processing apparatus 10.

The storage unit 22 temporarily or permanently stores data required for processing in the information processing apparatus 10. For example, the storage unit 22 stores the OS 25, the program, user-specified position correction information 40 (to be described later), and the like. Examples of the storage unit 22 include a volatile memory, a non-volatile memory, a hard disk drive (HDD), and the like.

The OS 25 is software that controls the operation of the information processing apparatus 10.

The bus 23 is a path that electric signals transmitted and received by the other components of the information processing apparatus 10 pass through. Control signals and data are transmitted and received between the components of the information processing apparatus 10 through the bus 23.

The display unit 13 includes, for example, a liquid crystal display or an organic electro-luminescence (EL) display. The touch panel 15 (an example of a controller) is an input device that detects touch operation made with a user's finger or a stylus pen. The touch panel 15 has its control area extending over a display area of display unit 13. The information processing apparatus 10 may further include, as a control member, a button or a slide switch physically provided on the information processing apparatus 10, in addition to the touch panel 15. The information processing apparatus 10 is capable of changing (reduce/enlarge) display magnification of an image in accordance with user's control (pinch-in/pinch-out control) made on the touch panel 15 to display the image on the display unit 13.

The visible light camera 17 is an image capturing device that is sensitive to the visible light wavelength range and captures visible light reflected from a subject to produce an image (hereinafter, referred to as a “two-dimensional image”).

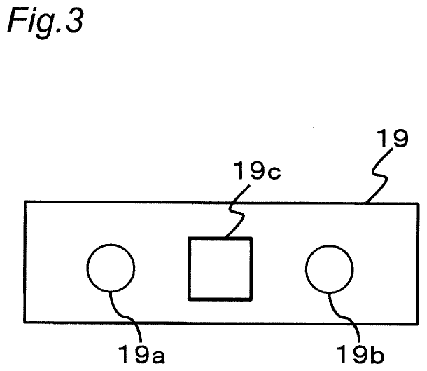

The distance-measuring camera unit 19 is a device that measures distance to each object within a subject and produces an image containing information on the distance to each object within the subject (hereinafter, referred to as a “distance image”). The distance-measuring camera unit 19 is implemented via various known techniques such as an active stereo system and a time of flight (TOF) system. FIG. 3 is a diagram showing an example of a structure of the distance-measuring camera unit 19. As shown in FIG. 3, the distance-measuring camera unit 19 includes a right infrared camera 19a, a left infrared camera 19b, and an infrared projector 19c. The distance-measuring camera unit 19 whose structure has been exemplified in FIG. 3 is configured to cause the infrared projector 19c to emit infrared rays in a specific pattern and perform calculation on the basis of a difference between images acquired by the right infrared camera 19a and the left infrared camera 19b to measure distance to the object.

The processor 21 can acquire the information on distance from the information processing apparatus 10 to each position on the two-dimensional image by superimposing the two-dimensional image produced by the visible light camera 17 and the distance image produced by the distance-measuring camera unit 19.

Note that, in the present embodiment, the visible light camera 17 has been described as a component separate from the distance-measuring camera unit 19, but the visible light camera 17 is not limited to such a structure and may be a part of the distance-measuring camera unit 19. Further, for example, the right infrared camera 19a and/or the left infrared camera 19b may serve as not only an infrared camera but also a visible light camera.

Note that the components described above may form the information processing apparatus 10 as physically separate components, or alternatively, some of the components may be integrated into the information processing apparatus 10. For example, the processor 21, the storage unit 22, and some or all of the functions of the other components are integrated and contained into one large scale integration (LSI).

Further, other components that are physically separate may be combined to form each of the components described above. For example, a plurality of physically different storage units may be used to form a logically single storage unit 22.

Further, in order to decentralize the load on the processor 21, a plurality of processors or a microcomputer contained in the storage unit 22 may perform actual processing. According to the present embodiment, components that perform these processes are generically defined as the processor 21.

### [1-1-2. Structure of User-Specified Position Correction Information]

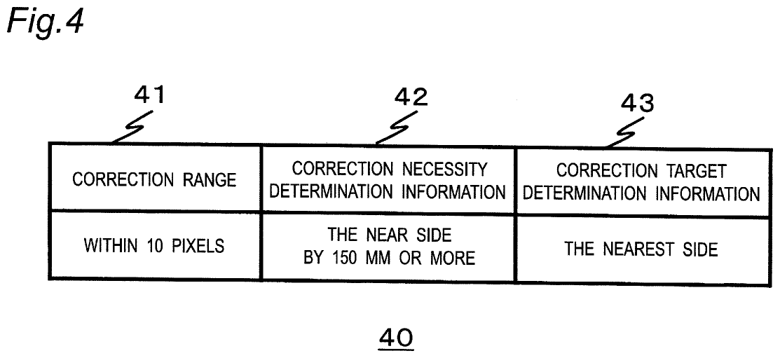

The user-specified position correction information 40 contains information representing a condition for determination of whether to correct the user-specified position specified by the user via the touch panel 15 with respect to the two-dimensional image displayed on the display unit 13 and how the correction is made when the correction is required. FIG. 4 is a diagram showing an example of the user-specified position correction information 40. As shown in FIG. 4, the user-specified position correction information 40 contains correction range 41, correction necessity determination information 42, and correction target determination information 43. The processor 21 confirms whether each position on the two-dimensional image within the range specified by the correction range 41 from the user-specified position satisfies the condition specified by the correction necessity determination information 42 on the basis of the information on distance measured by the distance-measuring camera unit 19 and determines, when positions that satisfy the condition are present, a correction target from the positions that satisfy the condition in accordance with the information specified by the correction target determination information 43. In the example shown in FIG. 4, the processor 21 confirms whether each position within a range of 10 pixels from the user-specified position on the two-dimensional image displayed on the display unit 13 is located on a near side by 150 mm or more relative to the distance from an information processing terminal 10 to the user-specified position on the basis of the information on distance measured by the distance-measuring camera unit 19 and determines, when positions located on the near side by 150 mm or more are present, a position located on a nearest side as a correction target from the positions. Hereinafter, a user-specified position before correction is referred to as “user-specified position (before correction)”, and a user-specified position after correction is referred to as “user-specified position (after correction)”. When no position within the range specified by the correction range 41 from the user-specified position on the two-dimensional image satisfies the condition specified by the correction necessity determination information 42, the processor 21 determines the user-specified position (before correction), as it is, as the user-specified position (after correction).

### [1-2. Operation]

The operation of the information processing apparatus 10 configured as described above will be described.

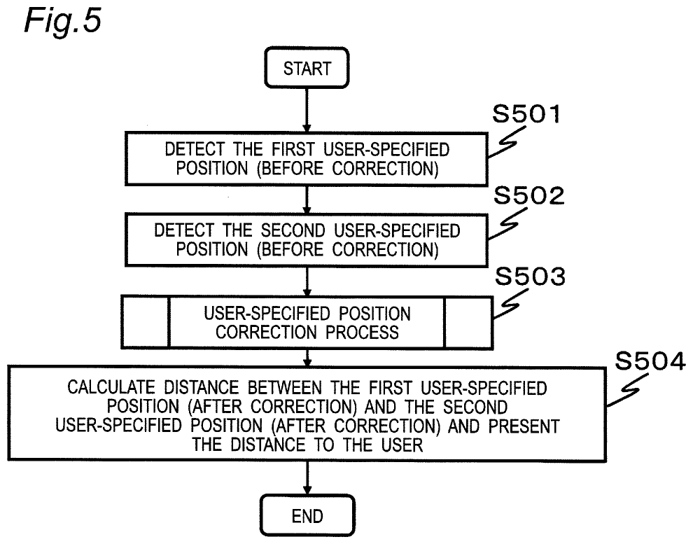

The information processing apparatus 10 according to the present embodiment has a function of displaying the two-dimensional image acquired by the visible light camera 17 on the display unit 13, calculating the distance between two user-specified positions specified by the user via the touch panel 15 with respect to the two-dimensional image displayed on the display unit 13 on the basis of the information on distance measured by the distance-measuring camera unit 19, and presenting the distance to the user. FIG. 5 is a flowchart showing operation of the information processing apparatus 10 according to the present embodiment, in which the information processing apparatus 10 performs the above function.

(Step S501) The processor 21 displays the two-dimensional image acquired by the visible light camera 17 on the display unit 13 to prompt the user to input a first user-specified position. When the user specifies a position via the touch panel 15 in response to the above, the processor 21 detects the specified position as the first user-specified position (before correction).

(Step S502) The processor 21 displays the two-dimensional image acquired by the visible light camera 17 on the display unit 13 to prompt the user to input a second user-specified position. When the user specifies a position via the touch panel 15 in response to the above, the processor 21 detects the specified position as the second user-specified position (before correction).

(Step S503) The processor 21 performs a user-specified position correction process (to be described later) on both the first user-specified position (before correction) detected in S501 and the second user-specified position (before correction) detected in step S502 to determine a first user-specified position (after correction) and a second user-specified position (after correction).

(Step S504) The processor 21 calculates distance between the first user-specified position (after correction) and the second user-specified position (after correction) determined in step S503 on the basis of the information on distance acquired by the distance-measuring camera unit 19 and presents the distance to the user via the display unit 13.

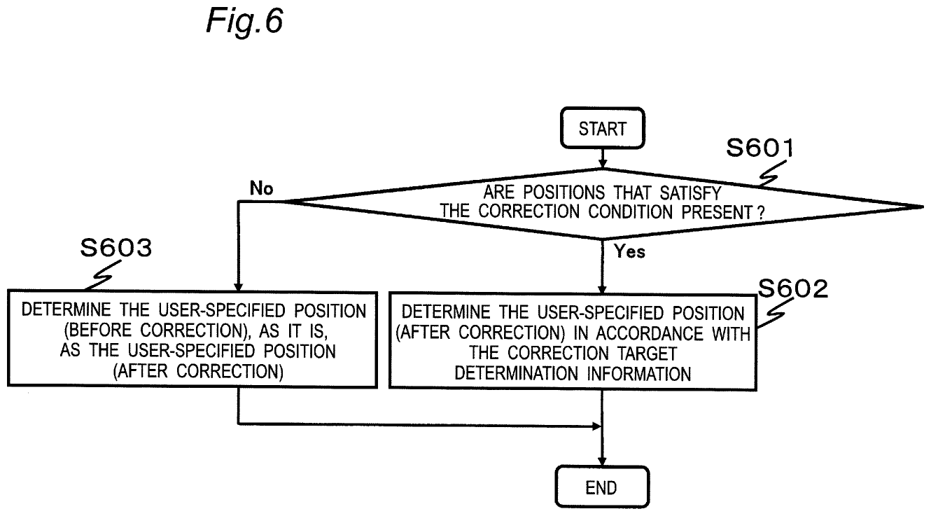

FIG. 6 is a flowchart showing operation of the information processing apparatus 10 according to the present embodiment, in which the information processing apparatus 10 performs the user-specified position correction process.

(Step S601) The processor 21 browses the user-specified position correction information 40 stored in the storage unit 22 to confirm whether each position on the two-dimensional image within the range specified by the correction range 41 from the user-specified position (before correction) satisfies the condition specified by the correction necessity determination information 42. For the confirmation, the processor 21 acquires the information on distance from the information processing apparatus 10 to each position on the two-dimensional image by superimposing the two-dimensional image produced by the visible light camera 17 and the distance image produced by the distance-measuring camera unit 19. When any position satisfies the condition, the process proceeds to step S602. When no position satisfies the condition, the process proceeds to step S603. When the user-specified position correction information 40 has the same content as shown in the example in FIG. 4, the processor 21 confirms whether each position within 10 pixels from the user-specified position (before correction) on the two-dimensional image displayed on the display unit 13 is located on the near side by 150 mm or more relative to the distance from the information processing terminal 10 to the user-specified position (before correction).

(Step S602) The processor 21 determines the user-specified position (after correction) in accordance with the correction target determination information 43. When the user-specified position correction information 40 has the same content as shown in the example in FIG. 4, the processor 21 selects a position located on the nearest side from among the positions determined to satisfy the condition in step S601 on the basis of the information on distance measured by the distance-measuring camera unit 19 to determine the position as the user-specified position (after correction).

(Step S603) The processor 21 determines the user-specified position (before correction), as it is, as the user-specified position (after correction).

As described above, the information processing apparatus 10 according to the present embodiment corrects the position specified by the user on the two-dimensional image using the information on distance to each position on the two-dimensional image. This allows the user to specify a desired position more accurately.

Note that the description has been given of the correction range 41 with a range of within a predetermined pixel (“within 10 pixels” in FIG. 4) from the user-specified position (before correction) as an example, but the correction range 41 is not limited to such a range, and it is also possible to set a range with consideration given to, for example, not only the information on the range of within the predetermined pixel, but also information on direction from the user-specified position (before correction), the two points of the first user-specified position (before correction) and the second user-specified position (before correction), or the like. For example, it is conceivable that, for example, “a range of within a predetermined pixel from a straight line connecting the first user-specified position (before correction) and the second user-specified position (before correction)” is set.

Note that the description has been given of the correction necessity determination information 42 with a near side by a predetermined value or more (“neat side by 150 mm or more” in FIG. 4) relative to the user-specified position (before correction) as an example, but the correction necessity determination information 42 is not limited to such a condition, and it is also possible to set, for example, “a far side by a predetermined value or more” or “having a distance of a predetermined value or more” regardless of whether it is a near side or a far side.

Note that the description has been given of the correction target determination information 43 with “nearest side” as an example, but the correction target determination information 43 is not limited to such a condition, and it is also possible to make, for example, a setting on distance from the user-specified position (before correction) or a setting with consideration given to the two points of the first user-specified position (before correction) and the second user-specified position (before correction). For example, it is conceivable that, for example, “a position closest to the user-specified position (before correction) on a straight line connecting the first user-specified position (before correction) and the second user-specified position (before correction)” is set.

### [1-3. Effects and Others]

As described above, the information processing apparatus 10 according to the present disclosure has the function of measuring information on distance to each position on the two-dimensional image and correcting the position specified by the user on the two-dimensional image on the basis of the information on distance. This allows the user to specify a desired position more accurately. For example, when a scene containing a narrow subject such as a power line or an overhead line of a railway is captured, it is possible to accurately specify such a subject located at a short distance relative to a background. Further, even when a subject appears to be assimilated with the background during, for example, nighttime shooting, it is possible to accurately specify the subject located at a short distance and more accurately specify the position even under conditions where it is difficult to specify the position with image recognition.

The present disclosure is applicable to information processing apparatuses having the function of measuring a spatial distance. Specifically, the present disclosure is applicable to tablet terminals, personal computers, smartphones, wearable computers, and the like.

What is claimed is:

1. An information processing apparatus comprising:
a processor configured to control a whole of the information processing apparatus;
a display unit;
an input unit layered on the display unit;
a visible light camera configured to acquire a visible image of a subject; and
a distance-measuring camera configured to measure distance to each object in the subject, wherein
the processor
displays the visible image acquired by the visible light camera on the display unit,
detects a user-specified position on the visible image specified by a user via the input unit, and
confirms whether a position located on a near side by a predetermined distance or more relative to the user-specified position is present within a predetermined range on the visible image from the user-specified position detected on the visible image on a basis of information on distance measured by the distance-measuring camera and corrects, when positions located on the near side by the predetermined distance or more are present within the predetermined range, the user-specified position to a position located on a nearest side out of the positions.
